(19) United States
(12) Patent Application Publication
(10) Pub. No.: US 2010/0075851 A1
(43) Pub. Date: Mar. 25, 2010

(54) DOSAGE FORM WITH SUSTAINED RELEASE RATE FOR WATER-SOLUBLE AND/OR WATER-INSOLUBLE SUBSTANCES

(76) Inventor: Phillip Mertens, Denkendorf (DE)

Correspondence Address: JACOBSON HOLMAN PLLC, 400 SEVENTH STREET N.W., SUITE 600, WASHINGTON, DC, 20004, US

(21) Appl. No.: 12/448,939

(22) PCT Filed: Jan. 22, 2008
(86) PCT No.: PCT/EP2008/050702

§ 371 Date: Nov. 20, 2009

(30) Foreign Application Priority Data
Jan. 22, 2007 (EP) 07100929.4

(51) Int. Cl. A01N 25/10; C05F 11/00

(52) U.S. Cl. 504/101; 514/772.3; 514/770; 71/27

(57) ABSTRACT

A dosage form with a sustained release rate for water-soluble and/or water-insoluble substances, such as fertilizers and/or nutrients and/or protecting agents for plants, animals and microorganisms in aquacultures, characterized in that said substances are incorporated individually or in the form of mixtures with one another in a finely divided form in a support insoluble in water, from which they are released in defined amounts over time at a highly reduced rate, the support being an elastomer cross-linked by high energy radiation.

The present invention relates to a dosage form with a sustained release rate for water-soluble and/or water-insoluble substances, such as fertilizers and/or nutrients and/or protecting agents for plants, animals and microorganisms in aquacultures, processes for the preparation of such dosage forms and the use thereof.

Water-soluble fertilizers and/or nutrients and/or protecting agents for plants, animals and microorganisms in aquacultures should be available over an extended period of time in approximately constant concentrations if possible in order to ensure optimum conditions of growth and health maintenance.

This can be achieved among others by metering the fertilizers and/or nutrients and/or protecting agents continuously at a corresponding dosage or in small portions. However, this requires a substantial expenditure and at least high costs. In principle, there is an object of developing dosage forms from which the fertilizers and/or nutrients and/or protecting agents are released and thus made available at a sustained rate such as to be released in defined amounts over time, i.e., over an extended period of time, at approximately constant concentrations even into aqueous, especially aqueous flowing, media, namely aquacultures. However, no method that is generally applicable to all water-soluble and/or water-insoluble fertilizers and/or nutrients and/or protecting agents has been known to date.

From the German Laid-Open Specification 1 592 755, a fertilizer preparation with sustained release of fertilizer containing urea and other fertilizers in polyurethane foams has been known. This fertilizer preparation is suitable for use in soil cultures, since the incorporated urea can be released slowly by the moisture present in the soil.

This fertilizer preparation is completely unsuitable for aquacultures since the fertilizer can be leached out quickly under the influence of aqueous or flowing aqueous media due to the open-pore foam structure of the polymer, and a defined sustained release of fertilizer does not occur.

Further, from German Auslegeschrift 1 299 662, a plant growth medium has been known, particularly suitable for potted plants, that is also based on polyurethane foam as the supporting polymer and is suitable as a soil substitute for plant breeding. In this system, the fertilizers are chemically bound to ion-exchange resins, wherein the fertilizer ions are slowly released by the ion exchanger under the influence of moisture in soil systems.

However, in aqueous or flowing aqueous media, the release of the fertilizer contained occurs much too quickly within a few hours or days due to the foam structure of the supporting polymer and the ready access of water caused thereby.

Thus, both fertilizer systems mentioned here are not suitable for use in aqueous or flowing aqueous media, such as aquacultures, since the release of fertilizer occurs too quickly and is equivalent to fertilization with a liquid or powdery pure fertilizer.

Thus, the object of the invention has been mainly to develop novel dosage forms with a more strongly sustained release rate for water-soluble and/or water-insoluble fertilizers and/or nutrients and/or protecting agents for plants, animals and microorganisms in aquacultures that are readily and inexpensively prepared and can be respectively modified in such a way as to be also employable in aqueous media, especially also flowing ones, such as aquacultures. The release should take place in defined amounts over time and only during several days and weeks. Further, it is to be noted that all the materials employed are environment-friendly and harmless, do not have side effects and optionally can be readily disposed of or even recycled. Further, if possible, water-insoluble and almost water-insoluble substances should be provided as well.

These objects are achieved by incorporating said water-soluble and/or water-insoluble substances, such as fertilizers and/or nutrients and/or protecting agents, individually or in the form of mixtures in a finely divided form in a support insoluble in water, from which they are dissolved or leaked out only at a highly reduced rate, namely within several days or weeks. The support is made of an elastomer.

The substances are released in aquacultures, i.e., in standing or moving water, within several days up to several months, preferably within from 4 days to 4 months.

“At a highly reduced rate” means that the release of the components contained is retarded in a standing body of water at 23° C. by a factor of at least 2, preferably by a factor of at least 4, even more preferably by a factor of at least 10, as compared to the same material not bound within a support.

As elastomers, polymeric synthetic or natural rubbers and preferably silicone rubbers, which become completely insoluble in water upon cross-linking, may be used, in particular. After the incorporated substances have been leached out, these supports can be disposed of in an environmental-friendly way or recycled.

In contrast to the open-pore polyurethane foams of the prior art, the release of the fertilizers and/or nutrients and/or protecting agents takes place by permeation through the relatively thin walls of the polymer that surround the finely dispersed substances from all sides. Surprisingly, silicate modifying components that may optionally be contained also enable the slow release of substances virtually insoluble in water, but not of the water-insoluble supports.

The finely divided form of the substances is obtained, for example, already during the preparation by crystallization or by mechanical grinding.

In order to modify the release rates, additional silicate modifying components, such as amorphous or crystalline silicas, metal silicates, molecular sieves and/or sheet silicates may be added to the above components before the polymerization or cross-linking. The silicate modifying components serve to control the release of the fertilizers and/or nutrients and/or protecting agents and the trace elements contained. Additions of calcium carbonate, barium sulfate, calcium sulfate, silicon dioxide and non-crystalline silicas as well as mixtures thereof predominantly act as extenders.

Activity enhancers or activity mediators may further be added to the formulations. Wetting agents and chelators are particularly suitable for this purpose. Examples thereof include EDTA, HEEDTA, DTPA, NTA and their salts as well as multidentate substances.

The water-soluble fertilizers and nutrients used according to the invention at first include the salts of the elements of the first and second main groups as well as various auxiliary groups of the Periodic Table, namely sodium, potassium, calcium and magnesium, iron, manganese, zinc, copper, nickel, cobalt, molybdenum, tin, boron, vanadium. They further include the ammonium salts with inorganic and organic anions, such as chloride, sulfate, nitrate, phosphate, borate, molybdate, fluoride, iodide, vanadate, stannate, acetate, citrate, gluconate, maleate, adipate, some oxides and hydroxides as well as urea.

Organic fertilizers or organic nutrients are also suitable.

Within the scope of the examinations performed, it was also established that active ingredients for plant and animal protection, such as agents for disinfection (e.g., malachite green oxalate, crystal violet and methylene blue) or agents acting against parasites (e.g., metronidazole, flubendazole and mebendazole), may be incorporated as individual substances or in combination with one another and/or in combination with plant fertilizers into polymeric supports from which they are released in a defined manner over an extended period of time upon contact with aqueous or flowing aqueous systems.

The formulations and the release rates may further be modified by chemically inactive and non-toxic plasticizers, such as silicone oils, paraffinic oils, phthalates and/or adipates of glycol or glycerol as well as fatty acid esters.

The formulations contain the fertilizers and/or nutrients in amounts of from 0.1 to 60% by weight, preferably in amounts of from 1 to 50% by weight. The activity enhancers or activity mediators are preferably present in amounts of only from 0.1 to 10% by weight, especially in amounts of from 0.5 to 5% by weight. Typical amounts for silicate modifying components are up to 30% by weight.

If plasticizers are contained, their amounts are from 1 to 30% by weight, especially from 3 to 25% by weight. Preferably, less than 1% by weight of plasticizer is contained.

Typical compositions are thus (in parts):

| | |
|---|---|
| polymer | 100 |
| modifying components | 0-150 |
| depot fertilizers | 5-220 |
| depot animal and plant protecting agents | 0-50 |
| activity enhancers | 0-20 |
| extenders and processing aids | 0-50 |

The finished formulations are preferably tailored and are applied in the form of tablets, granules, flakes or pellets. The formulations may also be in defined geometric shapes, such as cubes, cylinders, octahedrons, spheres.

The process for the preparation of the dosage form includes mixing the water-soluble and/or water-insoluble substances with a polymerizable or cross-linkable polymer, followed by cross-linking the latter by high energy radiation, the support produced being an elastomer.

The preparation of the novel dosage forms is preferably effected by previously combining the substances with the silicate modifying components, being aggregated thereto or incorporated therein, and then mixing them with the organic support, or mixing them directly as a mixture with the organic support. Such polymerization is preferably effected by catalysts and/or cross-linking agents. However, it may also be effected by high-energy radiation, especially by alpha or beta rays. Radiation doses of from 10 to 200 kGy may be applied.

Natural rubbers and silicone rubbers above all have proven useful as uncross-linked, but cross-linkable substances.

Since the dosage forms are mostly tailored into tablets, granules, flakes or pellets, such tailoring may also be performed with insufficiently cross-linked intermediate products. The further polymerization or cross-linking, which will then be necessary, may still be effected thereafter when the products have already been tailored.

The retardations of the release of the individual fertilizers and/or nutrients and/or protecting agents as achieved according to the invention may be determined in the usual way. If required, the composition and preparation can be modified accordingly in such a way that the sought properties are achieved rather exactly for the respective field of application.

The used products, leached by water, consist of polymers insoluble in water. These can be readily separated from the aqua system and either disposed of or recycled.

The invention further relates to the use of a dosage form with a sustained release rate with a
support insoluble in water that is in the form of an elastomer cross-linked by high energy radiation; and
substances selected from fertilizers, nutrients, protecting agents and mixtures thereof;
   for incorporating fertilizers, nutrients and protecting agents into aquacultures.

1. A dosage form with a sustained release rate for water-soluble and/or water-insoluble substances selected from the group consisting of fertilizers, nutrients and protecting agents for aquacultures comprising plants, animals or microorganisms, wherein said substances are incorporated individually or in the form of mixtures with one another in a finely divided form in a support insoluble in water, from which they are released in defined amounts over time, the support being an elastomer cross-linked by high energy radiation.

2. The dosage form according to claim 1, characterized in that said support is made of natural rubber, synthetic rubber or silicone rubber.

3. The dosage form according to claim 1, characterized in that said substances within the support are in admixture with silicate modifying components selected from the group consisting of crystalline and amorphous silicas, metal silicates, molecular sieves and sheet silicates.

4. The dosage form according to claim 1, characterized in that said substances contain organic or inorganic fertilizer salts and/or trace elements and/or organic nutrients.

5. The dosage form according to claim 1, characterized by additionally containing activity enhancers or activity mediators.

6. The dosage form according to claim 5, characterized in that said activity enhancers or activity mediators are cross-linking agents or chelators.

7. The dosage form according to claim 1, characterized by being in the form of molded parts, tablets, granules, flakes or pellets.

8. A process for the preparation of dosage forms according to claim 1, wherein water-soluble and/or water-insoluble substances are mixed with a polymerizable or cross-linkable polymer, followed by cross-linking the latter by high energy radiation, the support produced being an elastomer.

9. The process according to claim 8, characterized in that said water-soluble and/or water-insoluble substances are either previously combined with the silicate modifying component, being aggregated thereto or incorporated therein, and then mixed with an organic polymerizable or cross-linkable polymer, or that said substances and the modifying components are directly mixed with a polymerizable or cross-linkable polymer, followed by solidification by cross-linking.

10. The process according to claim 9, characterized in that said cross-linking is triggered by alpha or beta rays.

11. The process according to claim 10, characterized in that said high energy radiation is employed in radiation doses of from 10 to 200 kGy.

12. The process according to claim 8, characterized in that plasticizers are added to the dosage forms before said polymerization or cross-linking.

13. The process according to claim 8, characterized in that the reaction mixture is tailored into molded parts, tablets, granules, flakes or pellets before or only after the cross-linking has been completed.

14. Use of a dosage form with a sustained release rate with a
support insoluble in water that is in the form of an elastomer cross-linked by high energy radiation; and
substances selected from fertilizers, nutrients, protecting agents and mixtures thereof;
for incorporating fertilizers, nutrients and protecting agents into aquacultures.

15. The use according to claim 14, characterized in that said dosage form additionally contains silicate modifying components selected from the group consisting of amorphous or crystalline silicas, metal silicates, molecular sieves and sheet silicates and/or additional activity enhancers or activity mediators.
